(19) United States
(12) Patent Application Publication
(10) Pub. No.: US 2011/0305942 A1
(43) Pub. Date: Dec. 15, 2011

(54) RECHARGEABLE BATTERY PACK

(75) Inventor: Kwang-Young Park, Yongin-si (KR)

(73) Assignee: Samsung SDI Co., Ltd., Yongin-si (KR)

(21) Appl. No.: 12/970,866

(22) Filed: Dec. 16, 2010

(30) Foreign Application Priority Data
Jun. 10, 2010 (KR) 10-2010-0054946

(51) Int. Cl. H01M 2/24

(52) U.S. Cl. 429/158

(57) ABSTRACT

A rechargeable battery pack according to an embodiment of the present invention includes: a first unit cell and a second unit cell formed by rechargeable batteries; a connection tab including a first plate portion and a second plate portion facing each other while forming a bent portion, wherein the connection tab is configured to connect an electrode terminal of the first unit cell to the first plate portion and is configured to connect an electrode terminal of the second unit cell to the second plate portion, wherein the first plate portion includes a first protrusion portion spaced from the bent portion by a predetermined distance and protruding toward the second plate portion, and the second plate portion includes a second protrusion portion protruding toward the first plate portion to contact the first protrusion portion.

### CROSS-REFERENCE TO RELATED APPLICATION

This application claims priority to and the benefit of Korean Patent Application No. 10-2010-0054946 filed in the Korean Intellectual Property Office on Jun. 10, 2010, the entire contents of which are incorporated herein by reference.

### BACKGROUND

1. Field

This disclosure relates to a rechargeable battery pack including a plurality of rechargeable battery cells.

2. Description of the Related Technology

With technological developments and increasing demand for mobile devices, demand for rechargeable batteries as an energy source has also increased. The rechargeable battery may be a single-cell type or a pack-type electrically connecting a plurality of cells depending on a kind of an apparatus using the rechargeable battery.

In general, a cylindrical rechargeable battery has a capacity larger than that of an angular rechargeable battery or a pouch-type rechargeable battery. Cylindrical rechargeable batteries are typically connected with each other in serial or in parallel to form a rechargeable battery pack in a linear or plate structure. The rechargeable battery pack typically includes a core pack formed by connecting a plurality of cylindrical rechargeable battery cells in serial or in parallel, and a connection tab electrically connecting a positive terminal and a negative terminal to a protection circuit.

For example, different electrodes of the rechargeable battery cells are typically welded to one surface of the connection tab and thereafter, the connection tab is bent and both sides of the connection tab are folded to form a core pack of a serial structure. Further, the same electrodes of the rechargeable battery cells are typically welded to one surface of the connection tab and thereafter, the connection tab is bent and both sides of the connection tab are folded to form a core pack of a parallel structure. That is, the rechargeable battery cells that are linearly arranged are electrically connected with each other by bending the connection tab. When the connection tab is bent, a bent portion is formed, and both sides of the connection tab are folded to each other around the bent portion.

In this case, both sides of the connection tab partitioned around the bent portion are free from each other. Therefore, the connection tab is separated from the bent portion to be bent and in this case, the connection has weak impact resistance by receiving stress in a rechargeable battery pack state.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a rechargeable battery pack having strong impact resistance because a connection tab bent precisely around a predetermined bent portion is provided.

An embodiment of the present invention provide a rechargeable battery pack that includes: a first unit cell and a second unit cell formed by rechargeable batteries; a connection tab including a first plate portion and a second plate portion facing each other while forming a bent portion, wherein the connection tab is configured to connect an electrode terminal of the first unit cell to the first plate portion and is configured to connect an electrode terminal of the second unit cell to the second plate portion, wherein the first plate portion includes a first protrusion portion spaced from the bent portion by a predetermined distance and protruding toward the second plate portion, and wherein the second plate portion includes a second protrusion portion protruding toward the first plate portion to contact the first protrusion portion.

The first protrusion portion may have a set first width and a set first length, the second protrusion portion may have a set second width and a set second length, and the first protrusion portion and the second protrusion portion may be parallel to each other.

A first center line of the first protrusion having the first width and a second center line of the second protrusion portion having the second width are spaced from each other by a set distance to be parallel to each other.

The first protrusion portion may comprise one protrusion, and the second protrusion portion may comprise two protrusions at both sides parallel to the first protrusion portion.

When the first protrusion portion is vertically cut in the direction of the first width, the first protrusion portion may form a convex curved cross-section in the first plate portion and when the second protrusion portion is vertically cut in the direction of the second width, the second protrusion portion may form the convex curved cross-section.

The first protrusion portion may have a convex curved cross-section having the set first width and be formed by a straight line having the first length and the second protrusion portion has a convex cross-section having the set second length and be formed by a straight line having the second length, and the first protrusion portion and the second protrusion portion may be parallel to each other.

The first protrusion portion may include a first protrusion portion parallel to the bent portion, and a second protrusion portion and a third protrusion portion crossing an extension line of the bent portion at both sides of the first protrusion portion and having extension lines forming a triangle with an extension line of the first protrusion portion.

The second protrusion portion may include a fourth protrusion portion parallel to the bent portion, and a fifth protrusion portion and a sixth protrusion portion crossing the extension line of the bent portion at both sides of the fourth protrusion portion and having extension lines forming the triangle with an extension line of the fourth protrusion portion.

The first plate portion may have three first welding holes disposing and welding three first unit cells in vertexes of an equilateral triangular structure, and the second plate portion may have three second welding holes disposing and welding three second unit cells in the vertexes of the equilateral triangular structure.

The first welding hole may have a set fourth width and a set fifth length, the second welding hole may have a set fifth width and a set fifth length, the three first welding holes may form extension lines having the fourth length established in the first plate to be parallel to each other, and the three second welding holes may form extension lines having the fifth length established in the second plate to be parallel to each other.

The first welding hole and the second welding hole may cross each other while the first plate portion and the second plate portions are folded toward each other.

The first protrusion portion may have a recess portion retracting in a direction opposite to a protruding direction at the center having the first width, and the second protrusion portion may be folded toward the recess portion of the first protrusion portion. The recess portion and the second protrusion portion may contact each other in a curve.

When the first protrusion portion may be vertically cut in the direction of the first width, a pointed angular cross-section may be formed in the first plate portion and when the second protrusion portion is vertically cut in the direction of the second width, a pointed angular cross-section may be formed in the second plate portion.

When the first protrusion portion is vertically cut in the direction of the first width, a convex trapezoid cross-section may be formed in the first plate portion and when the second protrusion portion is vertically cut in the direction of the second width, the convex trapezoid cross-section may be formed in the second plate portion.

The bent portion may include a bending leading line formed between the first plate and the second plate, and a bending start groove formed at least one side of the bending leading line.

According to an embodiment of the present invention, since a first protrusion portion is formed on a first plate and a second protrusion portion is formed on a second plate, when the first and second plates are bent and folded toward each other, the first and second protrusion portions closely contact each other, such that predetermined bending is achieved. The first and second plates are precisely folded toward each other for the connection tab to be free from stress due to deflective bending of the first and second plate portions. As a result, the connection tab may have strong impact resistance in a rechargeable battery pack state.

### BRIEF DESCRIPTION OF THE DRAWINGS

FIG. 1 is an exploded perspective view of a rechargeable battery pack according to a first embodiment of the present invention;

FIG. 2 is a cross-sectional view of a rechargeable battery used in the rechargeable battery pack of FIG. 1;

FIG. 3 is a plan view of an extended connection tab used in the rechargeable battery pack of FIG. 1;

FIG. 4 is a front view of a bent connection tab of FIG. 3;

FIG. 5 is a cross-sectional view taken along line V-V of FIG. 4;

FIG. 6 is a partial cross-sectional view of a connection tab used in a rechargeable battery pack according to a second embodiment of the present invention;

FIG. 7 is a partial cross-sectional view of a connection tab used in a rechargeable battery pack according to a third embodiment of the present invention;

FIG. 8 is a partial cross-sectional view of a connection tab used in a rechargeable battery pack according to a fourth embodiment of the present invention; and

FIG. 9 is a partial cross-sectional view of a connection tab used in a rechargeable battery pack according to a fifth embodiment of the present invention.

### DETAILED DESCRIPTION

The present invention will be described more fully hereinafter with reference to the accompanying drawings, in which certain embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

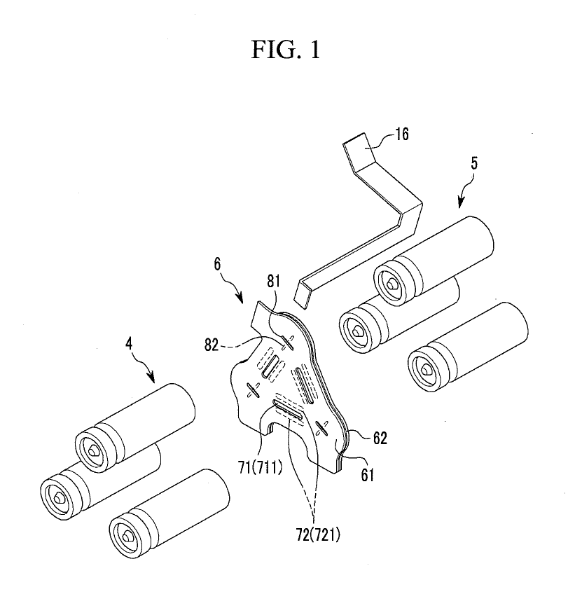

FIG. 1 is an exploded perspective view of a rechargeable battery pack according to a first embodiment of the present invention. The rechargeable battery packs 100 may be connected with each other in serial or in parallel to form a core pack, and can include at least one unit cell 4 and a second unit cell 5 formed by rechargeable batteries, and a connection tab 6 connecting electrodes of the first and second unit cells 4 and 5 to a protection circuit (not shown).

Each of the first and second unit cells 4 and 5 may be formed in single, but as shown in the figure, may be formed in plural (for example, three). In the rechargeable battery pack 100, three first unit cells 4 may be connected with each other in parallel at one side of the connection tab 6 and three second unit cells 5 may be connected with each other in parallel at the other side of the connection tab 6, such that the first and second unit cells 4 and 5 are connected with each other in serial at both bent sides.

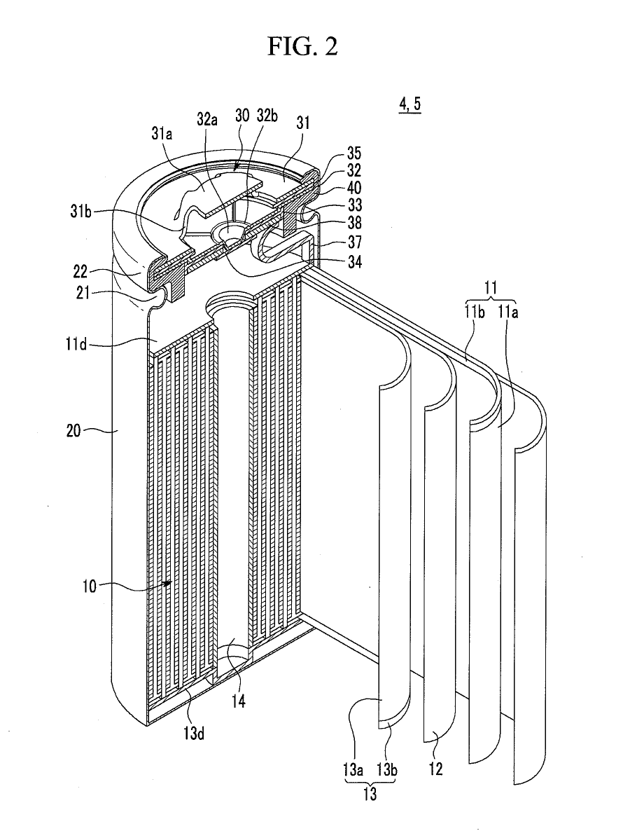

FIG. 2 is a cross-sectional view of a rechargeable battery used in the rechargeable battery pack of FIG. 1. Referring to FIG. 2, a rechargeable battery with the first and second unit cells 4 and 5 will be described. The first and second unit cells 4 and 5 can include an electrode assembly 10 generating current, a case incorporating the electrode assembly 10, and a cap assembly 30 combined with the case 20 to be electrically connected to the electrode assembly 10.

The electrode assembly 10 can include a first electrode (hereinafter, referred to as “positive electrode”) 11, a separator 12, and a second electrode (hereinafter, referred to as “negative electrode”) 13 that are stacked in sequence. The electrode assembly 10 may be formed by integrating the electrodes 11 and 12 and separator 13, which is an insulator, by winding the positive electrode 11 and the negative electrode 13, with the separator 12 interposed therebetween. For example, the electrode assembly 10 may be cylindrical. A sector pin 14 may be disposed at the center of the cylindrical electrode assembly 10. The sector pin 14 may maintain the cylindrical shape of the electrode assembly 10.

The positive electrode 11 and the negative electrode 13 may include coated portions 11 a and 13a where an active material is applied to both surfaces of a current collector formed by a thin-film metallic foil, and uncoated portions 11b and 13b where the active material is not applied at opposite sides of the current collector. In a jelly roll configuration, a positive current collector plate 11d may be connected to the uncoated portion 11b of the positive electrode 11 and a negative current collector plate 13d may be connected to the uncoated portion 13b of the negative electrode 13.

The case 20 may have one opened side to be inserted with the electrode assembly 10 and may be cylindrical to receive the cylindrical electrode assembly 10. The case 20 may be connected to a negative current collector plate 13d to serve as a negative terminal in the first and second unit cells 4 and 5, and be made of conductive metal such as aluminum, an aluminum alloy, or nickel plated steel.

The cap assembly 30 may be combined with the opened side of the case 20 with a gasket 40 interposed therebetween to seal the case 20 incorporating the electrode assembly 10 and an electrolyte solution. Further, the cap assembly 30 may be equipped with a current interrupting device to be electrically connected to the electrode assembly 10 through the current interrupting device. The cap assembly 30 can include a cap plate 31, a vent plate 32, an insulation plate 33, a sub-plate 34, a positive temperature coefficient element 35, and a middle plate 38.

The cap plate 31 may be finally connected to the positive current collector plate 11d to serve as a positive terminal in the first and second unit cells 4 and 5. A projection portion 31a projecting to the outside of the case 20 and an exhaust port 31b opened to the side of the projection portion 31a.

Substantially, the current interrupting device may be formed by the vent plate 32 and the sub-plate 34 and a connector of the current interrupting device may be formed by welding the vent plate 32 and the sub-plate 34 to each other. The vent plate 32 forming one side of the current interrupting device may be installed inside of the cap plate 31 and may be electrically connected to the sub-plate 34 forming the other side of the current interrupting device. Further, the vent plate 32 may be broken under a predetermined pressure condition to discharge gas in the first and second unit cells and can include a vent 32a formed to interrupt electrical connection with the sub-plate 34.

When the current interrupting device is actuated, that is, when connectors of the vent plate 32 and the sub-plate 34 are separated from each other due to breakage of the vent 32a, the electrode assembly 10 and the cap plate 31 become electrically isolated from each other. For example, the vent 32a projects toward the inside of the case 20 from the vent plate 32. The vent plate 32 may include a notch 32b guiding the breakage of the vent 32a around the vent 32a. When the pressure in the case 20 is increased to a predetermined pressure by gas generated in the case 20, the notch 32b is broken and discharges the gas so as to prevent the first and second unit cells 4 and 5 from exploding.

The positive temperature coefficient element 35 may be installed between the cap plate 31 and the vent plate 32 to control the flow of current between the cap plate 31 and the bent plate 32. When the temperature of operating conditions becomes higher than a predetermined temperature, the electrical resistance of the positive temperature coefficient element 35 can increase to up to an infinite range and as a result, the flow of charged or discharge current can be interrupted.

The sub-plate 34 may face the vent plate 32 with the insulation plate 33 interposed therebetween to be electrically connected to the vent 32a. The middle plate 38 may be interposed between the insulation plate 33 and the sub-plate 34. The vent 32a projecting through through-holes of the insulation plate 33 and the middle plate 38 may be connected to the sub-plate 34. Therefore, the middle plate 38 may be electrically connected to the vent plate 32 through the sub-plate 34 and the vent 32a at one side thereof and connected to the positive current collector plate 11d through a connection member 37 at the other side thereof. Finally, the positive current collector plate 11d may be electrically connected to the cap plate 31 through the connection member 37, the middle plate 38, the sub-plate 34, the vent 32a, the vent plate 32, and the positive temperature coefficient element 35.

The cap assembly 30 formed as described above can engage in the case 20 and may be fixed to the case 20 through clamping to complete each of the first and second unit cells 4 and 5. In this case, a beading portion 21 and a clamping portion 22 may be formed.

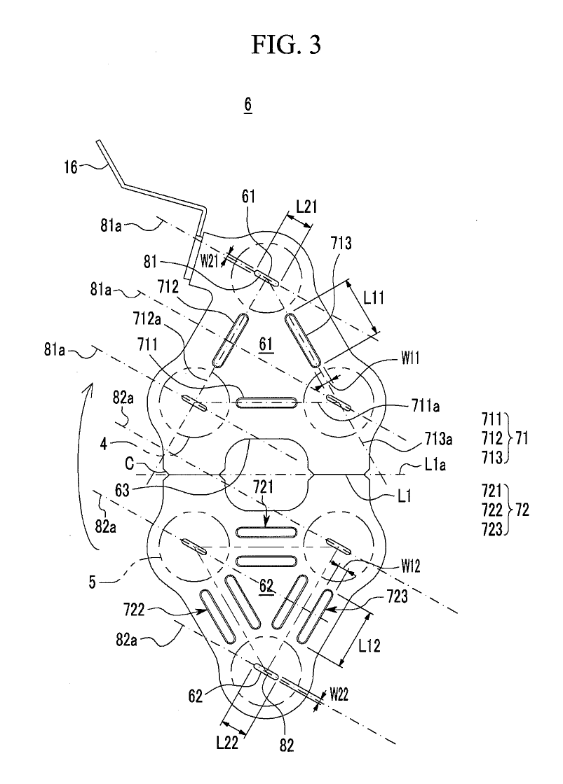

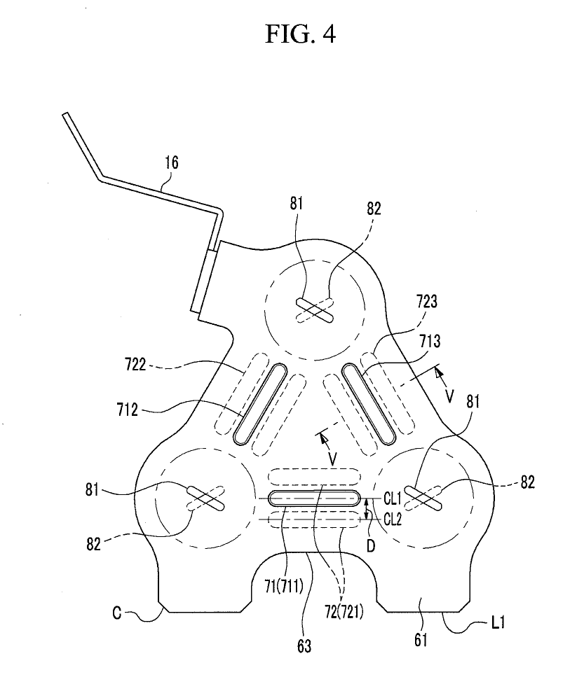

FIG. 3 is a plan view of an extended connection tab used in the rechargeable battery pack of FIG. 1 and FIG. 4 is a front view of a bent connection tab of FIG. 3. Referring to FIGS. 3 and 4, the connection tab 6 may include a first plate portion 61 and second plate portions 62 that are bent and folded to each other while forming a bent portion in an unfolded state. The first and second plate portions 61 and 62 may be bent and folded to each other along a bending leading line L1.

A bending leading line L1 may be established between the first and second plate portions 61 and 62 and may have bent start grooves C at both ends thereof. That is, the bending leading line L1 may be established in a straight line between the bending start grooves C. The bent start grooves C may partially cut a space between the first and second plate portions 61 and 62 connected to each other at the end of the bending leading line L1 to be formed in a V-shaped groove with respect to the surfaces of the first and second plate portions 61 and 62, thereby facilitating the start of bending by setting bending start positions of the first and second plate portions 61 and 62.

The bending leading line L1 may be one line (not shown) continuously linked between the first and second plate portions 61 and 62, but as shown in the figure, may be at least two lines separated from each other. Even in the case in which the bending leading line L1 is formed in plural, extension line L1a forms one straight line, wherein the extension line L1a is an imaginary line extending along the bending leading line L1. The bending start grooves C and the bending leading line L1 set the portions to be bent while the first and second plate portions 61 and 62 are unfolded, and then facilitate bending of the first and second plate portions 61 and 62 so that they are folded towards each other.

For example, the connection tab 6 may form a substantially tetragonal opening 63 between the first and second plate portions 61 and 62 while being unfolded and may separate the bending leading line L1 into two at both sides of the opening 63. In this case, the bending start grooves C may be formed at each of both sides of the bending leading line L1 separated into two. The bending start grooves C can facilitate the start of the bending of the first and second plate portions 61 and 62 at both separated sides of the bending leading line L1.

The connection tab 6 may connect an electrode terminal of the first unit cell 4 to the first plate portion 61 and also connect an electrode terminal of the second unit cell 5 to the second plate portion 62 while being unfolded to be bent around the bending leading line L1. Therefore, the first and second unit cells 4 and 5 may be connected to both sides of the connection tab 6 in serial or in parallel.

The first and second plate portions 61 and 62 can include first and second protrusion portions 71 and 72 that contact each other during bending or after bending is completed. The first and second protrusion portions 71 and 72 may contact each other to induce a repulsive force acting in a direction parallel to planes of the first and second plate portions 61 and 62, thereby causing the first and second plate portions 61 and 62 from being precisely bent along the bending leading line L1 at the time of bending the first and second plate portions 61 and 62. In an ideal state in which the first and second plate portions 61 and 62 are precisely bent along the bending leading line L1, the repulsive force may not be applied between the first and second protrusion portions 71 and 72.

The first protrusion portion 71 of the first plate portion 61 may be spaced from the bent portion, or the bending leading line L1, by a predetermined distance to protrude toward the second plate portion 62. The second protrusion portion 72 of the second plate portion 62 may be spaced from the bent portion, or the bending leading line L1, by a predetermined distance to protrude toward the first plate portion 61 and thus closely contact the first protrusion portion 71.

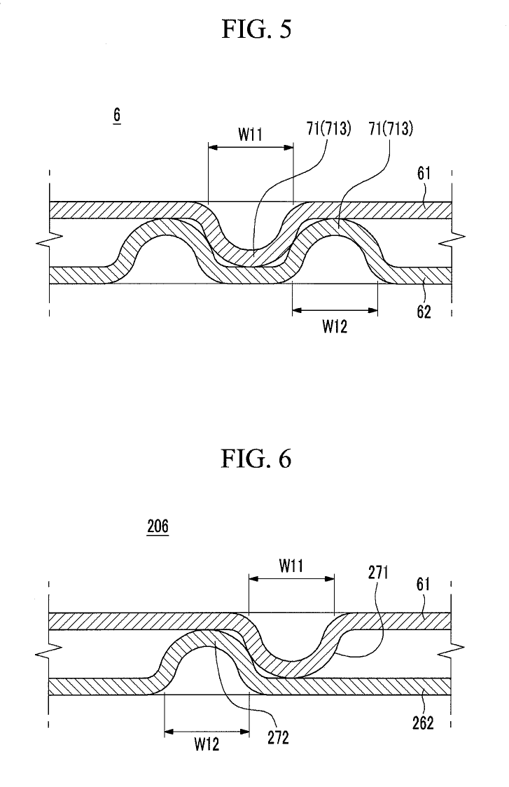

FIG. 5 is a cross-sectional view taken along line V-V of FIG. 4. Referring to FIGS. 3 to 5, the first protrusion portion 71 may have a set eleventh width W11 and a set eleventh length L11 and when the first protrusion portion 71 is vertically cut in the direction of the eleventh width W11, the first protrusion portion 71 may have a convex curved cross-section in the first plate portion 61. The second protrusion portion 72 may have a set twelfth width W12 and a set twelfth length L12 and when the second protrusion portion 72 is vertically cut in the direction the twelfth width W12, the second protrusion portion 72 may have the convex curved cross-section in the second plate portion 62.

The first and second protrusion portions 71 and 72 may be parallel to each other. In the first and second protrusion portions 71 and 72, the eleventh and twelfth lengths L11 and L12 may be formed in a curve (not shown), but as shown in the figure, they may be formed in a straight line. For convenience of manufacturing, in the first and second protrusion portions 71 and 72, the eleventh and twelfth widths W11 and W12 may be different from or the same as each other and the eleventh and twelfth lengths L11 and L12 may be different from or the same as each other.

Meanwhile, a first center line CL1 of the eleventh width W11 in the first protrusion portion 71 and a second center line CL2 of the twelfth width W12 in the second protrusion portion 72 may be spaced from each other by a set distance D to be parallel to each other at positions.

The first protrusion portion 71 may be formed by one protrusion and the second protrusion portion 72 may be formed by two protrusions at both sides parallel to the first protrusion portion 71. Therefore, when the first and second plate portions 61 and 62 are bent, the first protrusion portion 71 can enable more precise bending with respect to the bending leading line L1 by receiving repulsive force by the second protrusion portion 72 disposed at both sides.

Referring back to FIGS. 3 and 4, the first protrusion portion 71 of the first plate portion 61 can include an eleventh protrusion portion 711, a twelfth protrusion portion 712, and a thirteenth protrusion portion 713 that are disposed on three sides of a triangle formed by the extension line on the first plate portion 61, wherein the extension lines 711a, 712a and 713a are imaginary lines extending along each of an eleventh protrusion portion 711, a twelfth protrusion portion 712, and a thirteenth protrusion portion 713. For better comprehension and ease of description, the twelfth protrusion portion 711 may be parallel to the bending leading line L1, and the extension lines 712a and 713a of the twelfth and thirteenth protrusion portion 712 and 713 may cross the extension line L1a of the bending leading line L1 at both sides of the eleventh protrusion portion 711.

The second protrusion portion 72 of the second plate portion 62 can include a twenty-first protrusion portion 721, a twenty-second portion 722, and a twenty-third protrusion portion 723 disposed on three sides of the triangle formed by the extension line on the second plate 62. For better comprehension and ease of description, the twenty-first protrusion portion 721 may be parallel to the bending leading line L1, and the twenty-second and twenty-third protrusion portion 722 and 723 may cross the extension line of the bending leading line L1 at both sides of the twenty-first protrusion portion 721.

The first protrusion portion 71 and the second protrusion portion 72 may be formed by one pair facing each other, but any one of the first and second protrusion portions may be disposed on three sides of the triangle formed by the extension line and the other one may be disposed to correspond to one side among three sides of the triangle (not shown).

As shown in the figure, when the first protrusion portion 71 and the second protrusion portion 72 are formed by three pairs of the eleventh, twelfth, and thirteenth protrusion portions 711, 712, and 713 and the twenty-first, twenty-second, and twenty-third protrusion portions 721, 722, and 723 that are disposed to correspond to three sides constituting the triangle formed by the extension line, the first and second plate portions 61 and 62 can be more precisely bent with respect to the bending leading line L1.

Further, the connection tab 6 where each of the first and second protrusion portions 71 and 72 is formed in three pairs in the first and second plate portions 61 and 62 may have a triangular structure and may be effectively used when three of each of first and second unit cells 4 and 5 are connected.

Meanwhile, the first and second plate portions 61 and 62 can include three first and second welding holes 81 and 82 disposing and welding three first unit cells 4 in vertexes of a triangular, more specifically, equilateral triangular structure, respectively. Three first welding holes 81 having the set twenty-first width W21 and the twenty-first length L21 may be formed in the first plate portion 61, and extension lines of the three first welding holes 81 may be parallel to each other. Three second welding holes 82 having the set twenty-second width W22 and the twenty-second length L22 may be formed in the second plate portion 62, and extension lines of the three second welding holes 82 may be parallel to each other.

Further, the first and second welding holes 81 and 82 may be parallel to each other while the first and second plate portions 61 and 62 are unfolded on a plane surface to cause a welding equipment (not shown) to be traveled in the same direction so as to improve welding efficiency. That is, the first and second welding holes 81 and 82 can cross each other while the first and second plate portions 61 and 62 are bent and folded to each other. For convenience of manufacturing, in the first and second welding holes 81 and 82, the twenty-first and twenty-second widths W21 and W22 may be different from or the same as each other and the twenty-first and twenty second lengths L21 and L22 may be different from or the same as each other.

The connection tab 6 can include a drawing tab 16 at any one of the first and second plate portions 61 and 62. In the connection tab 6 of the first described embodiment, the drawing tab 16 may be connected to the first plate portion 61 to be connected to a protection circuit (not shown).

Hereinafter, various embodiments of the present invention will be described and description of the same component will be omitted and different components are compared with each other by comparing with the first exemplary embodiment and the following embodiments.

FIG. 6 is a partial cross-sectional view of a connection tab used in a rechargeable battery pack according to a second embodiment of the present invention. Referring to FIG. 6, in the connection tab 206 of the second embodiment, the first protrusion portion 71 of the first plate portion 61 may be formed by one and a second protrusion portion 272 of a second plate portion 262 may be formed by one protrusion portion at one side in parallel to the first protrusion portion 271.

The first and second protrusion portions 271 and 272 contact each other to induce a repulsive force acting in a direction parallel to planes of the first and second plate portions 61 and 262, thereby causing the first and second plate portions 61 and 262 from being bent along a bending leading line L1 at the time of bending the first and second plate portions 61 and 262. In comparison with the connection tab 6 of the first described embodiment, the direction of the repulsive force is limited to one direction in the connection tab 206 of the second described embodiment.

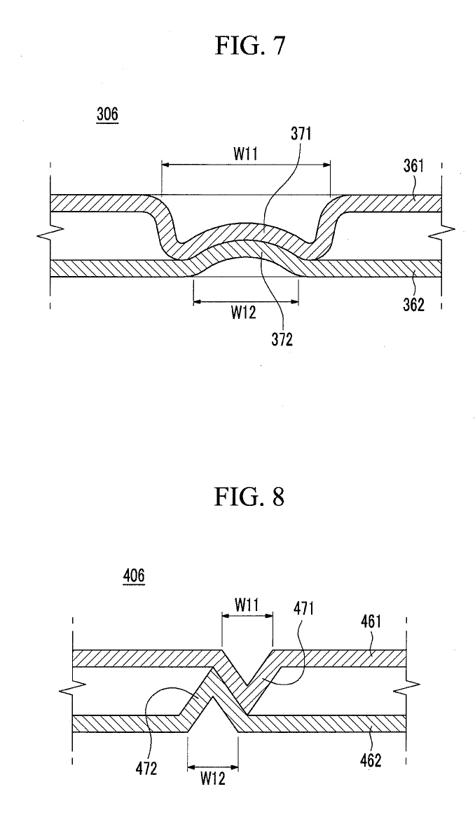

FIG. 7 is a partial cross-sectional view of a connection tab used in a rechargeable battery pack according to a third embodiment of the present invention. Referring to FIG. 7, in the connection tab 306 of the third embodiment, a first protrusion portion 371 of a first plate portion 361 has a recess portion 373 formed at the center having an eleventh width W11 to retract in a direction opposite to a protrusion direction and a second protrusion portion 372 is folded to the recess portion 373 of the first protrusion portion 371. The recess portion 373 and the second protrusion portion 372 may contact each other in a curve.

The recess portion 373 of the first protrusion portion 371 and the second protrusion portion 372 may closely contact each other while contacting each other in the curve to induce a repulsive force acting in a direction parallel to planes of the first and second plate portions 361 and 362, thereby causing the first and second plate portions 361 and 362 from being bent along a bending leading line L1 at the time of bending the first and second plate portions 361 and 362. In this case, a center line of the recess portion 372 having an eleventh width W11 and a center line of the second protrusion portion 372 having a twelfth width W12 may coincide with each other.

FIG. 8 is a partial cross-sectional view of a connection tab used in a rechargeable battery pack according to a fourth embodiment of the present invention. Referring to FIG. 8, in the connection tab 406 of the fourth embodiment, when a first protrusion portion 471 is vertically cut in the direction of an eleventh width W11, the first protrusion portion 471 forms a pointed angular cross-sectional in a first plate portion 461 and when a second protrusion portion 472 is vertically cut in the direction of a twelfth width W12, the second protrusion portion 472 forms the pointed angular cross-section in a second plate portion 462.

The first and second protrusion portions 471 and 472 may closely contact each other in a slope to induce a repulsive force acting in a direction parallel to planes of the first and second plate portions 461 and 462, thereby causing the first and second plate portions 461 and 462 from being bent along a bending leading line L1 at the time of bending the first and second plate portions 461 and 462.

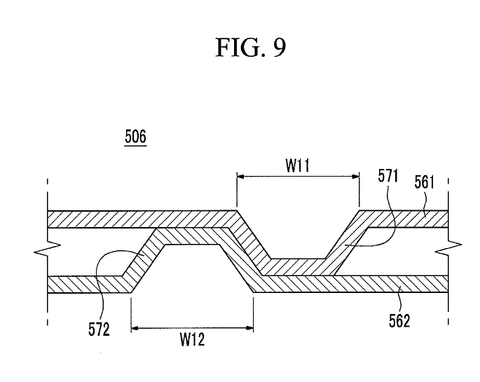

FIG. 9 is a partial cross-sectional view of a connection tab used in a rechargeable battery pack according to a fifth embodiment of the present invention. Referring to FIG. 9, in the connection tab 506 of the fifth embodiment, when a first protrusion portion 571 is vertically cut in the direction of an eleventh width W11, the first protrusion portion 571 forms a convex trapezoid cross-sectional in a first plate portion 561 and when a second protrusion portion 572 is vertically cut in the direction of a twelfth width W12, the second protrusion portion 572 forms the convex trapezoid cross-section in a first plate portion 561.

The first and second protrusion portions 571 and 572 may closely contact each other in a slope to induce a repulsive force acting in a direction parallel to planes of the first and second plate portions 561 and 562, thereby causing the first and second plate portions 561 and 562 from being bent along a bending leading line L1 at the time of bending the first and second plate portions 561 and 562. The first and second protrusion portions 571 and 572 forming a trapezoid plane contact maintain bending states of the first and second plate portions 561 and 562 more stably.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery pack, comprising:
a first unit cell and a second unit cell formed by rechargeable batteries;
a connection tab including a first plate portion and a second plate portion facing each other while forming a bent portion, wherein the connection tab is configured to connect an electrode terminal of the first unit cell to the first plate portion and is configured to connect an electrode terminal of the second unit cell to the second plate portion,
wherein the first plate portion includes a first protrusion portion spaced from the bent portion by a predetermined distance and protruding toward the second plate portion, and
wherein the second plate portion includes a second protrusion portion protruding toward the first plate portion to contact the first protrusion portion.

2. The rechargeable battery pack of claim 1, wherein:
the first protrusion portion has a predetermined first width and a predetermined first length,
the second protrusion portion has a predetermined second width and a predetermined second length, and
the first protrusion portion and the second protrusion portion are parallel to each other.

3. The rechargeable battery pack of claim 2, wherein:
a first center line of the first protrusion having the first width and a second center line of the second protrusion portion having the second width,
are spaced from each other by a predetermined distance such that they are parallel to each other.

4. The rechargeable battery pack of claim 2, wherein:
the first protrusion portion comprises one protrusion, and
the second protrusion portion comprises one protrusion at one side parallel to the first protrusion.

5. The rechargeable battery pack of claim 2, wherein:
the first protrusion portion comprises one protrusion, and
the second protrusion portion comprises two protrusions at both sides parallel to the first protrusion.

6. The rechargeable battery pack of claim 2, wherein:
when the first protrusion portion is vertically cut in the direction of the first width, the first protrusion portion forms a convex curved cross-section in the first plate portion, and
when the second protrusion portion is vertically cut in the direction of the second width, the second protrusion portion forms a convex curved cross-section in the second plate portion.

7. The rechargeable battery pack of claim 1, wherein:
the first protrusion portion has a convex curved cross-section having the predetermined first width and is formed by a straight line having the first length,
the second protrusion portion has a convex curved cross-section having the predetermined second width and is formed by a straight line having the second length, and
the first protrusion portion and the second protrusion portion are parallel to each other.

8. The rechargeable battery pack of claim 7, wherein:
the first protrusion portion includes an first protrusion portion parallel to the bent portion, a second protrusion portion and a third protrusion portion, wherein the first protrusion, the second protrusion and the third protrusion are arranged in a triangle configuration.

9. The rechargeable battery pack of claim 7, wherein:
the second protrusion portion includes a fourth protrusion portion parallel to the bent portion, a fifth protrusion portion and a sixth protrusion portion, wherein the fourth protrusion portion, the fifth protrusion portion and the sixth protrusion portions are arranged in a triangle configuration.

10. The rechargeable battery pack of claim 1, wherein:
the first plate portion has three welding holes for welding three unit cells at vertexes of an equilateral triangular configuration, and
the second plate portion has three welding holes for welding three unit cells at vertexes of an equilateral triangular configuration.

11. The rechargeable battery pack of claim 10, wherein:
the first welding hole has a predetermined fourth width and a predetermined fourth length,
the second welding hole has a predetermined fifth width and a predetermined fifth length,
the three welding holes are formed on the first plate, wherein extension lines of the three welding holes of the first plate are parallel to each other, and
the three welding holes are formed on the second plate, wherein extension lines of the three welding holes are parallel to each other.

12. The rechargeable battery pack of claim 11, wherein:
the first welding hole and the second welding hole overlap when the first plate portion and the second plate portions are folded toward each other.

13. The rechargeable battery pack of claim 2, wherein:
the first protrusion portion has a recess portion retracting in a direction opposite to a protruding direction, wherein the recess has the first width, and
the second protrusion portion is folded toward the recess portion of the first protrusion portion.

14. The rechargeable battery pack of claim 13, wherein:
the recess portion and the second protrusion portion contact each other in a curve.

15. The rechargeable battery pack of claim 2, wherein:
when the first protrusion portion is vertically cut in the direction of the first width, a pointed angular cross-section is formed in the first plate portion, and
when the second protrusion portion is vertically cut in the direction of the second width, a pointed angular cross-section is formed in the second plate portion.

16. The rechargeable battery pack of claim 2, wherein:
when the first protrusion portion is vertically cut in the direction of the first width, a convex trapezoid cross-section is formed in the first plate portion, and
when the second protrusion portion is vertically cut in the direction of the second width, the convex trapezoid cross-section is formed in the second plate portion.

17. The rechargeable battery pack of claim 1, wherein:
the bent portion includes a bending leading line formed between the first plate and the second plate, and a bending start groove formed on at least one side of the bending leading line.
